(19) United States
(12) Patent Application Publication
(10) Pub. No.: US 2025/0103968 A1
(43) Pub. Date: Mar. 27, 2025

(54) TRAJECTORY STITCHING FOR ACCELERATING DIFFUSION MODELS

(71) Applicant: NVIDIA Corporation, Santa Clara, CA (US)

(72) Inventors: Zizheng Pan, Melbourne (AU); De-An Huang, Cupertino, CA (US); Weili Nie, Sunnyvale, CA (US); Zhiding Yu, Cupertino, CA (US); Chaowei Xiao, Seattle, WA (US); Anima Anandkumar, Pasadena, CA (US)

(21) Appl. No.: 18/821,611

(22) Filed: Aug. 30, 2024

Related U.S. Application Data
(60) Provisional application No. 63/540,598, filed on Sep. 26, 2023.

(51) Int. Cl. G06N 20/20

(52) U.S. Cl. CPC G06N 20/20

(57) ABSTRACT

Diffusion models are machine learning algorithms that are uniquely trained to generate high-quality data from an input lower-quality data. Diffusion probabilistic models use discrete-time random processes or continuous-time stochastic differential equations (SDEs) that learn to gradually remove the noise added to the data points. With diffusion probabilistic models, high quality output currently requires sampling from a large diffusion probabilistic model which corners at a high computational cost. The present disclosure stitches together the trajectory of two or more inferior diffusion probabilistic models during a denoising process, which can in turn accelerate the denoising process by avoiding use of only a single large diffusion probabilistic model.

### CLAIM OF PRIORITY

This application claims the benefit of U.S. Provisional Application No. 63/540,598 (Attorney Docket No. NVIDP1384+/23-SC-0820US01) titled “TRAJECTORY STITCHING FOR FAST SAMPLING OF DIFFUSION PROBABILISTIC MODELS,” filed Sep. 26, 2023, the entire contents of which is incorporated herein by reference.

### TECHNICAL FIELD

The present disclosure relates to accelerating diffusion models.

### BACKGROUND

Diffusion models are machine learning algorithms that are uniquely trained to generate high-quality data, and for this reason these models have emerged as a key pillar for computer vision tasks. Diffusion models are typically trained by gradually adding (Gaussian) noise to an original input data in a forward diffusion process and then learning to remove the noise in a reverse diffusion process. The trained diffusion model can then process an input low-quality data (e.g. having noise) to generate a higher-quality version of the data. This is often referred to as an inverse task.

One specific type of diffusion model is a diffusion probabilistic model, which is defined by discrete-time random processes or continuous-time stochastic differential equations (SDEs) that learn to gradually remove the noise added to the data points. Diffusion probabilistic models have demonstrated remarkable success in generating high-quality data among various real-world applications, such as text-to-image generation, audio synthesis and three-dimensional (3D) generation. Achieving high generation quality, however, is expensive due to the need to sample from a large diffusion probabilistic model, typically involving hundreds of denoising steps each of which requires a high computational cost.

Recent solutions for accelerating diffusion probabilistic models, including specifically speeding up the sampling process, have included (1) reducing the computational costs per step or (2) reducing the number of sampling steps. The first approach can be done by model compression through quantization and pruning, or by redesigning lightweight model architectures. The second approach reduces the number of steps either by distilling multiple denoising steps into fewer ones or by improving the differential equation solver. While both solutions can improve the efficiency of large diffusion probabilistic models, they assume that the computational cost of each denoising step remains the same and that a single model is used throughout the process. However, in reality these assumptions typically do not hold true since different steps in the denoising process will oftentimes exhibit quite distinct characteristics and since using the same model throughout is a suboptimal strategy for efficiency.

There is a need for addressing these issues and/or other issues associated with the prior art. For example, there is a need to perform a denoising process using at least two inferior diffusion probabilistic models whose trajectories are stitched together, which can in turn accelerate the denoising process by avoiding use of only a single large diffusion probabilistic model.

### SUMMARY

A method, computer readable medium, and system are disclosed to perform a denoising process using at least two inferior diffusion probabilistic models. An input is denoised over a first sequence of steps using a first diffusion probabilistic model to generate a first denoised version of the input. The first denoised version of the input is denoised over a second sequence of steps using a second diffusion probabilistic model to generate a second denoised version of the input, where the first diffusion probabilistic model is inferior to the second diffusion probabilistic model in at least one respect. The second denoised version of the input is output.

### BRIEF DESCRIPTION OF THE DRAWINGS

FIG. 1 illustrates a flowchart of a method to perform a denoising process using at least two inferior diffusion probabilistic models, in accordance with an embodiment.

FIG. 2 illustrates a block diagram of a sequence of inferior diffusion probabilistic models configured to perform a denoising process, in accordance with an embodiment.

FIG. 3 illustrates operation of the sequence of diffusion probabilistic models of FIG. 2 during a denoising process, in accordance with an embodiment.

FIG. 4 illustrates a flowchart of a method to use trajectory stitching of at least two inferior diffusion probabilistic models to provide text-to-image generation, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

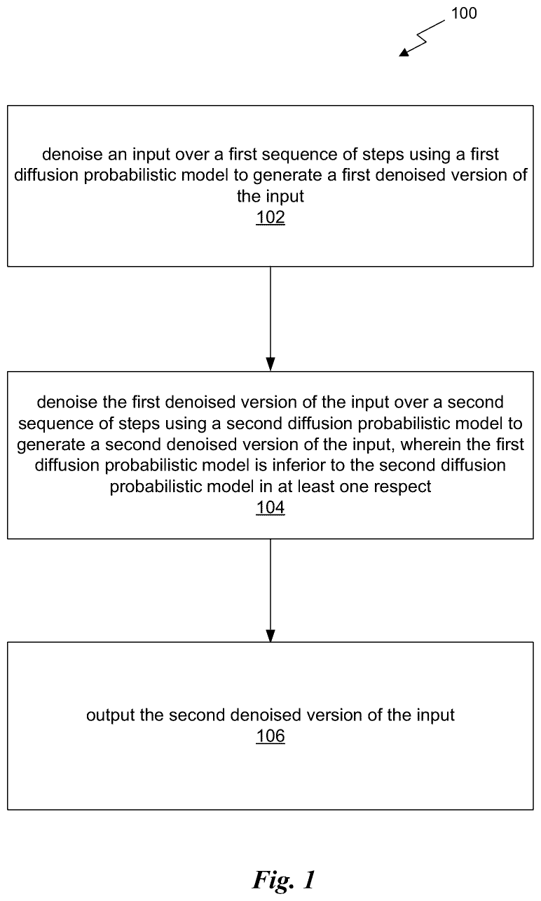

FIG. 1 illustrates a flowchart of a method 100 to perform a denoising process using at least two inferior diffusion probabilistic models, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned, the method 100 relates specifically to a denoising process performed by multiple diffusion probabilistic models, including at least a first diffusion probabilistic model and a second diffusion probabilistic model. In an embodiment, the first diffusion probabilistic model and the second diffusion probabilistic model may be preselected for processing an input. A diffusion probabilistic model refers to a machine learning model that has used discrete-time random processes or continuous-time stochastic differential equations (SDEs) to learn to gradually remove noise added to data points, and accordingly with respect to the present method 100 the diffusion probabilistic model has been trained to denoise a given input or in other words to generate data from noise. The noise refers to (e.g. random or pseudo-random) artifacts that are present in the data.

With respect to the present description, the diffusion probabilistic models have been pretrained for at least one particular task and thus able to perform a denoising process at inference time. In an embodiment, the diffusion probabilistic models may be trained for text-to-image generation. In an embodiment, the diffusion probabilistic models may be trained for audio synthesis. In an embodiment, the diffusion probabilistic models may be trained for three-dimensional (3D) content generation. In an embodiment, the diffusion probabilistic models may be trained for text-to-video generation. In an embodiment, the first diffusion probabilistic model and the second diffusion probabilistic model may be stable diffusion models. In an embodiment, the first diffusion probabilistic model and the second diffusion probabilistic model may be stylized stable diffusion models.

Referring back to the method 100, in operation 102, an input is denoised over a first sequence of steps using a first diffusion probabilistic model to generate a first denoised version of the input. The input refers to data of any type. In an embodiment, the input is an image. In an embodiment, the input is audio. In any case, the input is noisy, as mentioned above. The input may be noisy in terms of being a low-dimensional data in an embodiment. In an embodiment, the input may be noisy in terms of missing data.

As mentioned, the input is denoised over a first sequence of steps using, or by, the first diffusion probabilistic model. Denoising the input refers to removing noise from the input by generating new data to replace the noise. In an embodiment, a number of steps in the first sequence of steps may be preconfigured. In an embodiment, the first sequence of steps may be performed to iteratively denoise the input. Accordingly, the first sequence of steps may be first (e.g. initial) steps of a denoising process performed on the input.

As also mentioned above, the denoising of the input over the first sequence of steps using the first diffusion probabilistic model results in the generation of a first denoised version of the input. The first denoised version of the input may thus be denoised to a limited extent. In other words, the first denoised version of the input may not be fully denoised.

In operation 104, the first denoised version of the input is denoised over a second sequence of steps using a second diffusion probabilistic model to generate a second denoised version of the input. For example, the first denoised version of the input, which represents a partially denoised version of the input, may be provided (input) to the second diffusion probabilistic model for further denoising thereof over the second sequence of steps. In an embodiment, a number of steps in the second sequence of steps may be preconfigured.

In an embodiment, the second sequence of steps may be performed to iteratively denoise the first denoised version of the input that has been generated by the first diffusion probabilistic model. Accordingly, the second sequence of steps may be second (e.g. subsequent) steps of the denoising process performed for the input. In an embodiment, the second sequence of steps may complete the denoising of the input. In this embodiment, the second denoised version of the input may be fully denoised. In another embodiment, the second sequence of steps may only further partially denoise the input. In this embodiment, the second denoised version of the input may be denoised to a limited extent.

In any case, by performing on the input the first sequence of denoising steps and subsequently the second sequence of denoising steps using the first and second diffusion probabilistic model, respectively, trajectories of the first diffusion probabilistic model and the second diffusion probabilistic model may be stitched together. For example, in an embodiment, this trajectory stitching may be provided by a last step in the first sequence of steps outputting to a first step in the second sequence of steps. In other words, the first denoised version of the input generated by the first diffusion probabilistic model at the last step in the first sequence of steps may be output directly to the second diffusion probabilistic model for denoising through the second sequence of steps.

In the context of the present method 100, the first diffusion probabilistic model is inferior to the second diffusion probabilistic model in at least one respect. Thus, in an embodiment, the inferior first diffusion probabilistic model may be used to perform a first sequence of denoising steps on the input (in operation 102) and thereafter the superior second diffusion probabilistic model may be used to perform a second (subsequent) sequence of denoising steps on the input (in operation 104). In an embodiment, the first sequence of steps may generate lower frequency components from the input than the second sequence of steps. In another embodiment, the first sequence of steps may draw global structures for an image whereas the second sequence of steps may refine image details.

In an embodiment, the first diffusion probabilistic model may be inferior to the second diffusion probabilistic model as a result of the first diffusion probabilistic model being of a smaller size than the second diffusion probabilistic model. In an embodiment, the first diffusion probabilistic model may be inferior to the second diffusion probabilistic model as a result of the first diffusion probabilistic model having fewer parameters than the second diffusion probabilistic model. In an embodiment, the first diffusion probabilistic model may be inferior to the second diffusion probabilistic model as a result of the first diffusion probabilistic model being configured with less complexity than the second diffusion probabilistic model. For example, the first diffusion probabilistic model may include fewer floating-point operations (FLOPs) than the second diffusion probabilistic model.

In an embodiment, the first diffusion probabilistic model may be inferior to the second diffusion probabilistic model as a result of the second diffusion probabilistic model being a finetuned version of the first diffusion probabilistic model. The second diffusion probabilistic model may be finetuned by being trained further than the first diffusion probabilistic model, for example by being further trained with additional training data and additional training steps. In an embodiment, the first diffusion probabilistic model that is inferior to the second diffusion probabilistic model in at least one respect may be compressed. For example, the first diffusion probabilistic model may be compressed by reducing a number of steps it takes and/or by reducing its computational cost (e.g. reducing computational operations of the first diffusion probabilistic model). This compression may result in the first diffusion probabilistic model being inferior to the second diffusion probabilistic model or may cause an already inferior first diffusion probabilistic model to be even further inferior to the second diffusion probabilistic model.

While the first diffusion probabilistic model is inferior to the second diffusion probabilistic model in at least one respect, the first diffusion probabilistic model and the second diffusion probabilistic model may exhibit some similarities. These similarities may allow the first and second diffusion probabilistic models to be used in combination with one another, as described above, to denoise the same input. In an embodiment, the first diffusion probabilistic model and the second diffusion probabilistic model may be pretrained diffusion probabilistic models in a same model family. In an embodiment, the first diffusion probabilistic model and the second diffusion probabilistic model may be trained on a same training dataset or substantially similar training datasets. In an embodiment, the first diffusion probabilistic model and the second diffusion probabilistic model may be trained on a same data distribution.

In an embodiment, the first diffusion probabilistic model and the second diffusion probabilistic model may have a same architecture. In another embodiment, however, the first diffusion probabilistic model and the second diffusion probabilistic model may have different architectures. In an embodiment, the first diffusion probabilistic model and the second diffusion probabilistic model may be trained to perform a same task (e.g. text-to-image generation, video synthesis, etc.). In an embodiment, the first diffusion probabilistic model and the second diffusion probabilistic model may be configured with a same input and output shape, which may allow for the trajectory stitching mentioned above.

Employing an inferior first diffusion probabilistic model to perform the first sequence of denoising steps may allow for reduced computational overhead when compared with using the superior second diffusion probabilistic model for the entire denoising process. Although the inferior first diffusion probabilistic model may generate lower-dimensional data than the second diffusion probabilistic model, employing the second diffusion probabilistic model to perform the second sequence of denoising steps may allow for higher-dimensional data in the final denoised output of the second diffusion probabilistic model.

In operation 106, the second denoised version of the input is output. In an embodiment, the second denoised version may be output as a final output of a denoising process. For example, the second denoised version may be output for a downstream task (e.g. for display to a user, for input to a downstream application, etc.).

In an embodiment, the second denoised version of the input may be output to a third diffusion probabilistic model. The third diffusion probabilistic model may then denoise the second denoised version of the input over a third sequence of steps to generate a third denoised version of the input. In this embodiment, the third denoised version of the input may be output, for example as a final output of the denoising process or to even a fourth diffusion probabilistic model. The second diffusion probabilistic model may be inferior to the third diffusion probabilistic model in at least one respect.

To this end, the denoising process (e.g. of the method 100) may be performed on the input over any number of different diffusion probabilistic models, with each diffusion probabilistic model being inferior to the next in at least one respect.

Further embodiments will now be provided in the description of the subsequent figures. It should be noted that the embodiments disclosed herein with reference to the method 100 of FIG. 1 may apply to and/or be used in combination with any of the embodiments of the remaining figures below.

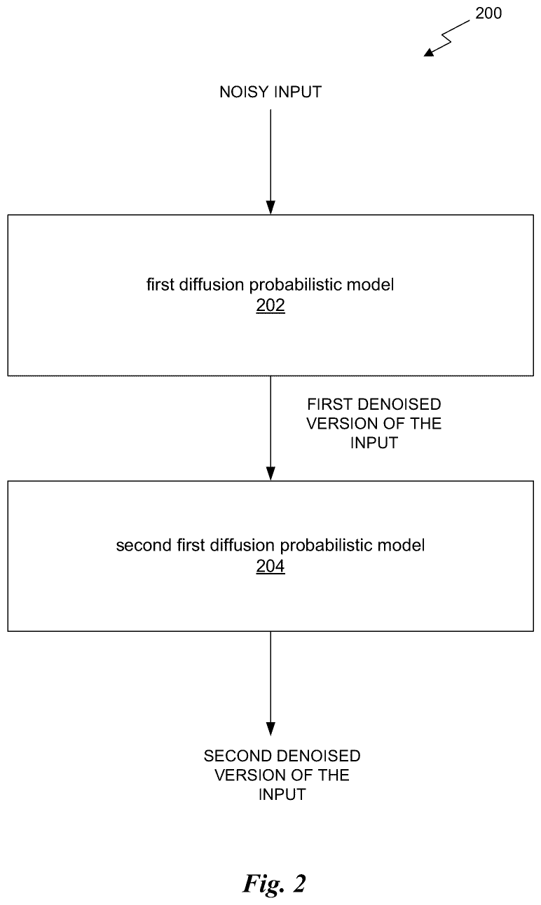

FIG. 2 illustrates a block diagram of a sequence 200 of inferior diffusion probabilistic models configured to perform a denoising process, in accordance with an embodiment. The sequence of inferior diffusion probabilistic models may be implemented to carry out the method 100 of FIG. 1, in an embodiment. Further, the descriptions and/or definitions given above may equally apply to the present embodiment.

As shown, the sequence 200 of diffusion probabilistic models includes at least a first diffusion probabilistic model 202 and a second diffusion probabilistic model 204. While the sequence 200 is referred to as being a sequence of models, it should be noted that the implementation may include in particular a sequence of denoiser components of the diffusion probabilistic models. The denoiser components may be parameterized neural networks with different architectures that consume FLOPs at each timestep.

In general, for a class of score-based diffusion models in a continuous time, assume p_{data}(x₀) denotes the data distribution and σ(t): [0, 1]→ [symbol] is a user-specified noise level schedule, where t∈{0, . . . , T} and σ(t−1)<σ(t). Let p(x; σ) denote the distribution of noised samples by injecting σ²-variance Gaussian noise. Starting with a high-variance Gaussian noise x^{T}, the diffusion models will gradually denoise x_{T} into less noisy samples {x_{T-1}, x_{T-2}, . . . , x₀}, where xₜ˜p(xₜ; σ(t)). Furthermore, this iterative process can be done by solving the probability flow ordinary differential equation (ODE) if knowing the score ∇ₓ log pₜ(x), namely the gradient of the log probability density with respect to data, per Equation 1.

$$dx = - \hat{σ} ( t ) σ ( t ) {∇}_{x} log p ( x ; σ ( t ) ) dt \qquad Equation 1$$

where \hat{σ}(t) denotes the time derivative of σ(t). Essentially, the diffusion models aim to learn a model for the score function, which can be re-parameterized per Equation 2.

$${∇}_{x} log {p}_{t} ( x ) \approx ( {D}_{θ} ( x ; σ ) - x ) / {σ}^{2} \qquad Equation 2$$

where D_{θ}(x; σ) is the learnable denoiser. Given a noisy data point x₀+n and a conditioning signal c, where n˜N(0, σ²I), the denoiser aims to predict the clean data x₀. In practice, the mode is trained by minimizing the loss of denoising score matching per Equation 3.

$${𝔼}_{( {x}_{0} , c} ) \sim {p}_{data} , ( σ , n ) [ {λ}_{σ} {‖ {D}_{θ} ( {x}_{0} + n ; σ , c ) - {x}_{0} ‖}_{2}^{2} ] \qquad Equation 3$$

where λ_{σ}: [symbol] → [symbol] , is a weighting function, p(σ, n)=p(σ)N(n; 0, σ²), and p(σ) is a distribution over noise levels σ.

Referring back to diagram in FIG. 2, the sequence 200 is configured such that the first diffusion probabilistic model 202 output to a second diffusion probabilistic model 204, or in other words such that the second diffusion probabilistic model 204 processes the output of the first diffusion probabilistic model 202. In the present embodiment, the first diffusion probabilistic model 202 is inferior to the second diffusion probabilistic model 204 in at least on respect. It should be noted that while only two diffusion probabilistic models 202, 204 are illustrated, the sequence 200 of diffusion probabilistic models may include any number of different diffusion probabilistic models whose inputs/outputs are connected in sequence and which are organized in the sequence 200 from most inferior to least inferior.

During a denoising process, a noisy input is provided to the first diffusion probabilistic model 202. The first diffusion probabilistic model 202 denoises the input over a first sequence of steps to generate a first denoised version of the input. The first denoised version of the input is output from the first diffusion probabilistic model 202 and provided to the second diffusion probabilistic model 204. The second diffusion probabilistic model 204 denoises the first denoised version of the input over a second sequence of steps to generate a second denoised version of the input. The second denoised version of the input is output from the second diffusion probabilistic model 204. The second denoised version of the input may be provided to a third diffusion probabilistic model in the sequence 200 or may represent a final denoised version of the input.

The sequential (i.e. linear) configuration of the diffusion probabilistic models 202, 204 from most inferior to least inferior can improve the sampling efficiency of the denoising process with little or no generation degradation, when compared with performing the denoising process using solely a superior diffusion probabilistic model. For example, instead of solely using a large diffusion probabilistic model for the entire sampling trajectory of the denoising process, the present configuration can first leverage a smaller diffusion probabilistic model in the initial steps of the denoising process as a cheap drop-in replacement of the larger diffusion probabilistic model and can then switch to the larger diffusion probabilistic model at a later stage. Since different diffusion models learn similar encodings under the same training data distribution and since smaller models are capable of generating good global structures in the early steps, the present configuration provides a training-free way to accelerate the denoising process while being generally applicable for different architectures and complementing other existing fast sampling techniques with flexible speed and quality trade-offs.

The number of denoising steps performed by each of the of the diffusion probabilistic models 202, 204 may be predefined. For example, a first percentage of the denoising process may be assigned (e.g. allocated) to the first diffusion probabilistic model 202 and a second percentage of the denoising process may be assigned to the second diffusion probabilistic model 204. With the increase in the percentage of steps from the first diffusion probabilistic model 202 instead of the superior the second diffusion probabilistic model 204, the inference speed may also increase. In an embodiment, up to 40% of the steps of the denoising process may be performed by the first diffusion probabilistic model 202 without degradation of the data generation quality. Nevertheless, the quality and efficiency trade-offs are a function of the percentage of steps assigned to each of the diffusion probabilistic models 202, 204. In an embodiment, the number of steps performed by each of the diffusion probabilistic models 202, 204 may be predetermined based on a given compute budget. For example, given a compute budget (e.g. time cost), a pre-computed lookup table of sequence configurations for different compute budgets may be referenced to determine a sequence configuration that will satisfy the compute budget.

Furthermore, in an embodiment, the part of the trajectory that is taken by the second diffusion probabilistic model 204 can be sped up by reducing the number of steps taken by it, or by reducing its computational cost with compression techniques. Still yet, while specific training of the sequence 200 of diffusion probabilistic models 202, 204 is not required to enable the denoising process to be performed across the diffusion probabilistic models 202, 204, in an optional embodiment the diffusion probabilistic models 202, 204 in the sequence 200 can be fine-tuned given a trajectory schedule. For example, by fine-tuning the second diffusion probabilistic model 204 on only the timesteps to which it is applied, the second diffusion probabilistic model 204 can better specialize in providing high-frequency details and further improve generation quality.

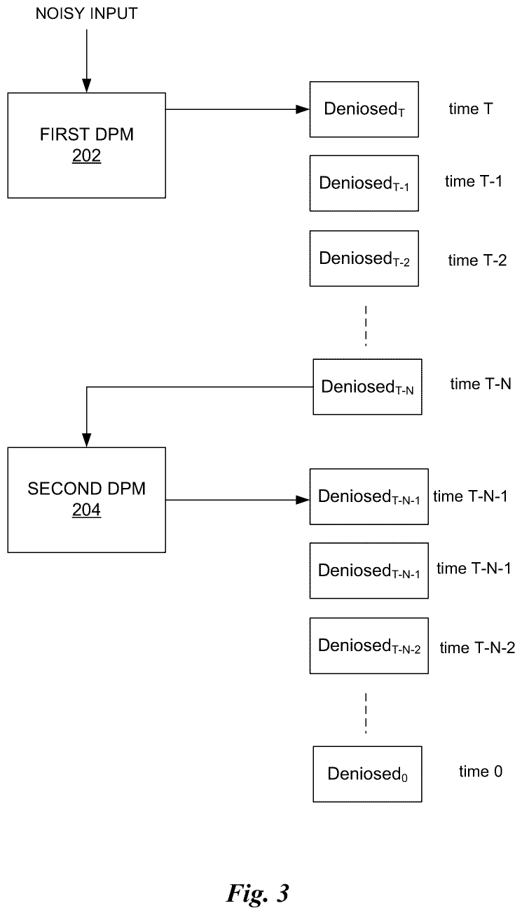

FIG. 3 illustrates operation of the sequence 200 of diffusion probabilistic models of FIG. 2 during a denoising process, in accordance with an embodiment. The present embodiment assumes the sequence 200 includes only the first diffusion probabilistic model 202 and the second diffusion probabilistic model 204. In the present embodiment, the denoising process is performed by the sequence 200 of diffusion probabilistic models from time T to time 0, with each time increment representing a denoising step of the denoising process.

The denoising process begins by providing a noisy input to the first diffusion probabilistic model 202. The first diffusion probabilistic model 202 iteratively denoises the input over a first sequence of steps performed from time T to time T-N. The denoised version of the input at time T-N is then output from the first diffusion probabilistic model 202 to the second diffusion probabilistic model 204. The second diffusion probabilistic model 204 then iteratively denoises the denoised version of the input from time T-N over a second sequence of steps performed from time T-N-1 to time 0.

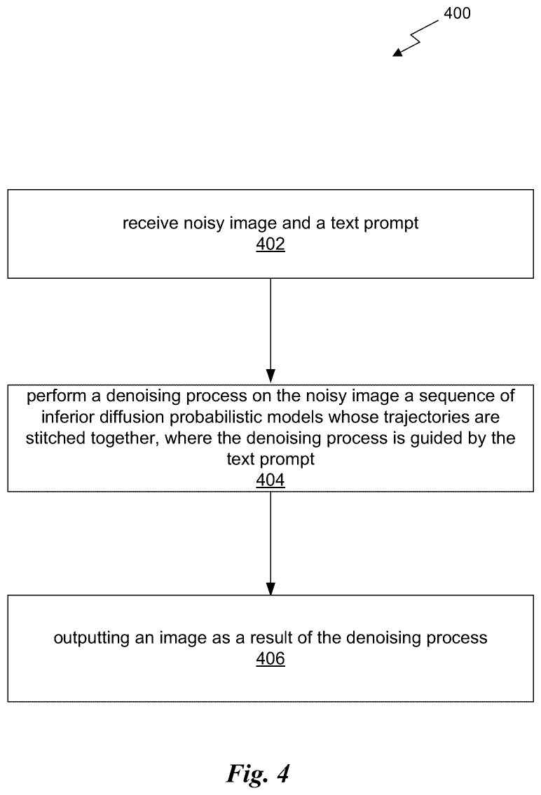

FIG. 4 illustrates a flowchart of a method 400 to use trajectory stitching of at least two inferior diffusion probabilistic models to provide text-to-image generation, in accordance with an embodiment.

In operation 402, a noisy image and text prompt are received. In an embodiment, the text prompt is a text string input by a user. In an embodiment, the noisy image is a sample image which may be input by the user or retrieved based on the text prompt.

In operation 404, a denoising process is performed on the noisy image using a sequence of inferior diffusion probabilistic models whose trajectories are stitched together, where the denoising process is guided by the text prompt. In the context of the present method 400, operation 404 is performed using the method 100 of FIG. 1 and/or the sequence 200 of inferior diffusion probabilistic models of FIG. 2. The denoising process generates an image that aligns with the text prompt.

In operation 406, an image is output as a result of the denoising process. As mentioned above, the image may be generated by the sequence of inferior diffusion probabilistic models to align with the text prompt.

By using the sequence of inferior diffusion probabilistic models for the text-to-image generation, the speed of such process may be improved as well as prompt alignment. In particular, the inferior (first in sequence) diffusion probabilistic model, which may be a general stable diffusion model, may complement the superior (second in sequence) diffusion probabilistic model, which may be a stylized stable diffusion model that specializes in stylizing the image. Just by way of example, a small general expert diffusion probabilistic model may be used at the beginning of the denoising process for fast sketching and better prompt alignment, while a larger stylized stable diffusion model may be used at the later steps for patiently illustrating details in the image.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

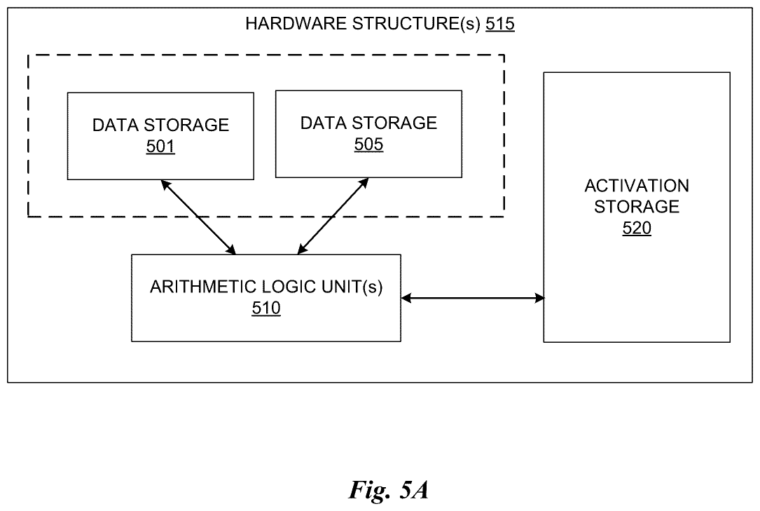

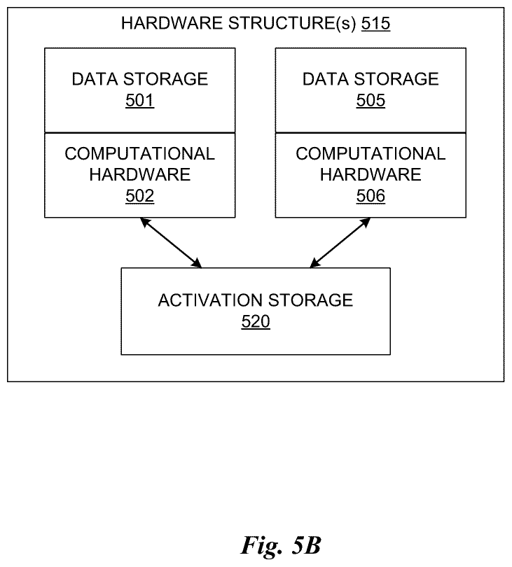

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

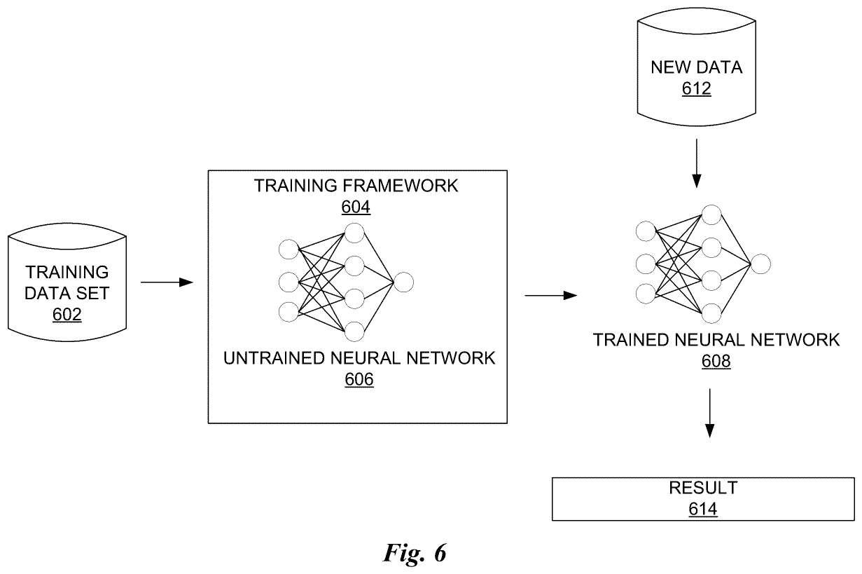

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

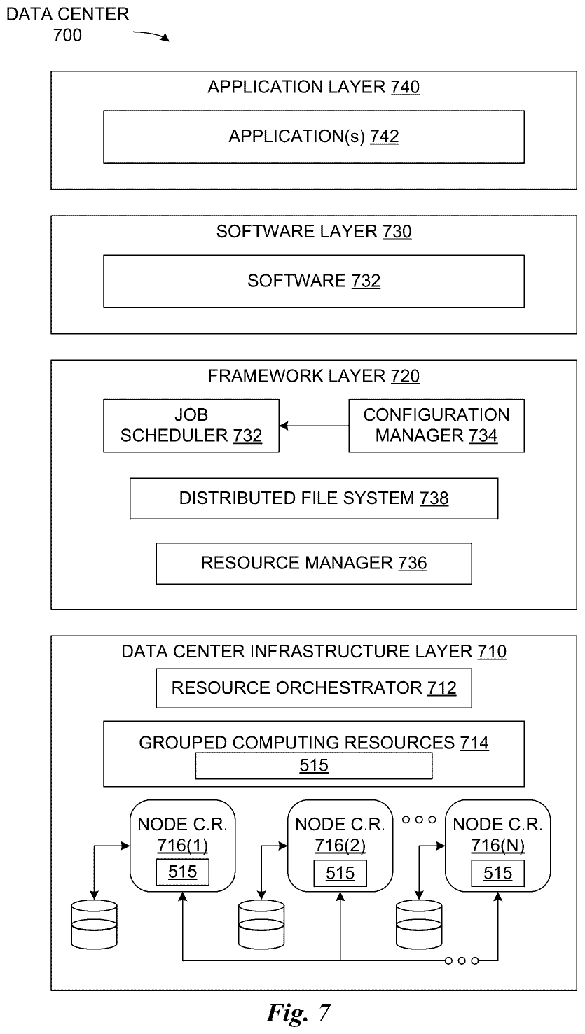

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide a denoising process that uses at least two inferior diffusion probabilistic models whose trajectories are stitched together. In accordance with FIGS. 1-4, embodiments may provide multiple diffusion models usable for performing inferencing operations and for providing inferenced data. The diffusion models may be stored (partially or wholly) in one or both of data storage 501 and 505 in inference and/or training logic 515 as depicted in FIGS. 5A and 5B. Training and deployment of the diffusion models may be performed as depicted in FIG. 6 and described herein. Distribution of the diffusion models may be performed using one or more servers in a data center 700 as depicted in FIG. 7 and described herein.

What is claimed is:

1. A method, comprising:
at a device:
denoising an input over a first sequence of steps using a first diffusion probabilistic model to generate a first denoised version of the input;
denoising the first denoised version of the input over a second sequence of steps using a second diffusion probabilistic model to generate a second denoised version of the input, wherein the first diffusion probabilistic model is inferior to the second diffusion probabilistic model in at least one respect; and
outputting the second denoised version of the input.

2. The method of claim 1, wherein the first diffusion probabilistic model and the second diffusion probabilistic model are pretrained diffusion probabilistic models in a same model family.

3. The method of claim 1, wherein the first diffusion probabilistic model and the second diffusion probabilistic model are trained on a same training dataset.

4. The method of claim 1, wherein the first diffusion probabilistic model and the second diffusion probabilistic model are trained on a same data distribution.

5. The method of claim 1, wherein the first diffusion probabilistic model and the second diffusion probabilistic model have a same architecture.

6. The method of claim 1, wherein the first diffusion probabilistic model and the second diffusion probabilistic model have different architectures.

7. The method of claim 1, wherein the first diffusion probabilistic model and the second diffusion probabilistic model are trained to perform a same task.

8. The method of claim 1, wherein the first diffusion probabilistic model and the second diffusion probabilistic model are configured with a same input and output shape.

9. The method of claim 1, wherein the first diffusion probabilistic model and the second diffusion probabilistic model are stylized stable diffusion models.

10. The method of claim 1, wherein the first diffusion probabilistic model is inferior to the second diffusion probabilistic model as a result of the first diffusion probabilistic model being of a smaller size than the second diffusion probabilistic model.

11. The method of claim 1, wherein the first diffusion probabilistic model is inferior to the second diffusion probabilistic model as a result of the first diffusion probabilistic model having fewer parameters than the second diffusion probabilistic model.

12. The method of claim 1, wherein the first diffusion probabilistic model is inferior to the second diffusion probabilistic model as a result of the first diffusion probabilistic model being configured with less complexity than the second diffusion probabilistic model.

13. The method of claim 12, wherein the first diffusion probabilistic model includes fewer floating-point operations (FLOPs) than the second diffusion probabilistic model.

14. The method of claim 1, wherein the first diffusion probabilistic model is inferior to the second diffusion probabilistic model as a result of the second diffusion probabilistic model being a finetuned version of the first diffusion probabilistic model.

15. The method of claim 1, wherein the first diffusion probabilistic model that is inferior to the second diffusion probabilistic model in at least one respect is further compressed.

16. The method of claim 15, wherein the first diffusion probabilistic model is compressed by reducing a number of steps it takes.

17. The method of claim 15, wherein the first diffusion probabilistic model is compressed by reducing its computational cost.

18. The method of claim 1, wherein the first sequence of steps and the second sequence of steps are steps of a denoising process.

19. The method of claim 1, wherein the first sequence of steps generates lower frequency components from the input than the second sequence of steps.

20. The method of claim 1, wherein a last step in the first sequence of steps outputs to a first step in the second sequence of steps.

21. The method of claim 1, wherein the first diffusion probabilistic model and the second diffusion probabilistic model are preselected for processing the input.

22. The method of claim 1, wherein a number of steps in the first sequence of steps and a number of steps in the second sequence of steps are preconfigured.

23. The method of claim 1, wherein the input is a noisy image.

24. The method of claim 1, wherein the input is a noisy audio.

25. The method of claim 1, wherein the first diffusion probabilistic model and the second diffusion probabilistic model are trained for text-to-image generation.

26. The method of claim 1, wherein the first diffusion probabilistic model and the second diffusion probabilistic model are trained for audio synthesis.

27. The method of claim 1, wherein the first diffusion probabilistic model and the second diffusion probabilistic model are trained for three-dimensional (3D) content generation.

28. The method of claim 1, wherein the first diffusion probabilistic model and the second diffusion probabilistic model are trained for text-to-video generation.

29. The method of claim 1, wherein the second denoised version of the input is output to a third diffusion probabilistic model.

30. The method of claim 29, wherein the third diffusion probabilistic model denoises the second denoised version of the input over a third sequence of steps to generate a third denoised version of the input, and wherein the third denoised version of the input is output.

31. The method of claim 29, wherein the second diffusion probabilistic model is inferior to the third diffusion probabilistic model in at least one respect.

32. A system, comprising:
a non-transitory memory storage comprising instructions; and
one or more processors in communication with the memory, wherein the one or more processors execute the instructions to:
denoise an input over a first sequence of steps using a first diffusion probabilistic model to generate a first denoised version of the input;
denoise the first denoised version of the input over a second sequence of steps using a second diffusion probabilistic model to generate a second denoised version of the input, wherein the first diffusion probabilistic model is inferior to the second diffusion probabilistic model in at least one respect; and
output the second denoised version of the input.

33. The system of claim 32, wherein the first diffusion probabilistic model is inferior to the second diffusion probabilistic model as a result of at least one of:
the first diffusion probabilistic model being of a smaller size than the second diffusion probabilistic model,
the first diffusion probabilistic model having fewer parameters than the second diffusion probabilistic model,
the first diffusion probabilistic model being configured with less complexity than the second diffusion probabilistic model, or
the second diffusion probabilistic model being a finetuned version of the first diffusion probabilistic model.

34. The system of claim 32, wherein the input is one of:
a noisy image, or
a noisy audio.

35. The system of claim 32, wherein the first diffusion probabilistic model and the second diffusion probabilistic model are trained for one of:
text-to-image generation,
audio synthesis
three-dimensional (3D) content generation, or
text-to-video generation.

36. A non-transitory computer-readable media storing computer instructions which when executed by one or more processors of a device cause the device to:
denoise an input over a first sequence of steps using a first diffusion probabilistic model to generate a first denoised version of the input;
denoise the first denoised version of the input over a second sequence of steps using a second diffusion probabilistic model to generate a second denoised version of the input, wherein the first diffusion probabilistic model is inferior to the second diffusion probabilistic model in at least one respect; and
output the second denoised version of the input.

37. The non-transitory computer-readable media of claim 36, wherein the first diffusion probabilistic model is inferior to the second diffusion probabilistic model as a result of at least one of:
the first diffusion probabilistic model being of a smaller size than the second diffusion probabilistic model,
the first diffusion probabilistic model having fewer parameters than the second diffusion probabilistic model,
the first diffusion probabilistic model being configured with less complexity than the second diffusion probabilistic model, or
the second diffusion probabilistic model being a finetuned version of the first diffusion probabilistic model.

38. The non-transitory computer-readable media of claim 36, wherein the input is one of:
a noisy image, or
a noisy audio.

39. The non-transitory computer-readable media of claim 36, wherein the first diffusion probabilistic model and the second diffusion probabilistic model are trained for one of:
text-to-image generation,
audio synthesis
three-dimensional (3D) content generation, or
text-to-video generation.
